(19) United States
(12) Patent Application Publication
(10) Pub. No.: US 2024/0384735 A1
(43) Pub. Date: Nov. 21, 2024

(54) ZERO OVERTRAVEL PUSH-PUSH MECHANISM

(71) Applicant: Pulse Biosciences, Inc., Hayward, CA (US)

(72) Inventor: Cameron D. Hinman, Thurman, NC (US)

(21) Appl. No.: 18/632,000

(22) Filed: Apr. 10, 2024

Related U.S. Application Data
(60) Provisional application No. 63/502,856, filed on May 17, 2023.

(51) Int. Cl. F16B 2/04

(52) U.S. Cl. CPC F16B 2/04

(57) ABSTRACT

Apparatuses, systems, and methods of the present disclosure provide push-to-open and push-to-close mechanisms with no (zero) overtravel. Further, for ease of the operation, the same motion is used to latch and unlatch (e.g., open and close) the device. As a result, the end of an instrument (e.g., medical clamp) never travels beyond the final latched/unlatched (e.g., open or closed) positions avoiding associated issues such as pain to a patient or tissue damage.

### CROSS-REFERENCES TO RELATED APPLICATIONS

This application claims the benefit of and priority to co-pending U.S. Provisional Patent Application No. 63/502,856, filed May 17, 2023, entitled “ZERO OVERTRAVEL PUSH-PUSH MECHANISM”, which is incorporated herein by reference in its entirety for all purposes.

### TECHNICAL FIELD

Described herein are mechanical assemblies for push-push (also referred to as push-to-open and push-to-close) mechanisms that require zero overtravel in order to latch and unlatch.

### BACKGROUND

Push-push mechanisms are a common way to latch and unlatch components. Push-push mechanisms are activated by applying a force in the same direction when opening or closing a device and by having two stable positions: open and closed. This type of mechanism is used in many devices such as ballpoint pens, drawer latches, cabinet latches, medical devices such as clamps, and so forth. In existing systems, these mechanisms require the item being latched to travel further than the final latched position (i.e., overtravel), then travel back a small distance to engage the latch. Similarly, when unlatching, overtravel is required in the latching direction to release the latch and return to the unlatched position.

This overtravel may not create issues in some applications. For example, cabinetry including doors and drawers and ballpoint pens may have overtravel without creating complications. However, in some applications, overtravel is not desirable. For example, in medical devices, overtravel may apply additional pressure to tissue, potentially causing damage.

To address overtravel, some devices have been developed that use differing mechanisms to open than to close. For example, a device may use a pushing mechanism to open, but a different motion or mechanism to close the device. This requires the user to remember which motion is needed to close. Further, these other motions may not be desirable in medical applications.

### SUMMARY

Described herein is an apparatus, a system, and associated methods having a push-to-open and push-to-close mechanism with zero overtravel. According to one aspect, an apparatus of the present disclosure may include: a plunger configured to move between an uncompressed position and a compressed position; a torsion mechanism coupled to the plunger and configured to rotate in response to the movement of the plunger; a stopping mechanism coupled to the torsion mechanism and configured to move axially between a proximal position and a distal position in response to the rotation of the torsion mechanism. The apparatus may also include a shaft coupled to the stopping mechanism and configured to extend to an extended position in response to the stopping mechanism moving to the distal position and retract to a retracted position in response to the stopping mechanism moving to the proximal position. The shaft does not extend past the extended position at any time when the plunger moves between the compressed and uncompressed positions and accordingly experiences zero overtravel.

Implementations may include one or more of the following features. In some embodiments, the torsion mechanism is configured to rotate at least a portion of a turn about a longitudinal axis of the plunger in response to each axial movement of the plunger towards the compressed position. In some embodiments, the torsion mechanism may be configured to lock rotationally after each axial movement of the plunger towards the compressed position. In some embodiments, the apparatus is latched in the extended position.

In some embodiments, the torsion mechanism may include a rotator coupled to the plunger and configured to rotate in response to each axial movement (e.g., depression) of the plunger to the compressed position. The torsion mechanism may further include a ratchet coupled to the rotator and configured to rotate with the rotator. The torsion mechanism may further include a stop base with ratchet positions that is configured to lock the torsion mechanism rotationally and apply rotational force to a torsion spring. Additionally, the torsion mechanism may include the torsion spring coupled to the stop base and configured to apply bias to the stopping mechanism.

In some embodiments, the torsion mechanism may include a rotator coupled to the plunger and configured to rotate in response to each movement (e.g., depression) of the plunger. The torsion mechanism may also include a torsion spring housing coupled to the rotator and configured to rotate with the rotator and apply rotational force to the torsion spring. The torsion mechanism may further include a one-way roller clutch coupled to the rotator and configured to lock the torsion mechanism rotationally. The torsion mechanism may also include the torsion spring configured to apply rotational force to the stopping mechanism.

In some embodiments, the apparatus may further include a clamping mechanism coupled to the shaft and configured to open to an unclamped position and close to a clamped position in response to the shaft movement between the extended and the retracted positions. In some embodiments, the clamping mechanism further may include an electrode configured to apply, for example, nanosecond pulses to tissue enclosed within the clamping mechanism in the clamped position.

In some embodiments, the stopping mechanism may include a housing that has at least one proximal face corresponding to the proximal position, at least one distal face corresponding to the distal position, and channels connecting the proximal faces and the distal faces. The stopping mechanism may also comprise a stop cap that includes flanges seated within the channels of the housing and configured to move axially along the channels. In some embodiments, the stop cap is coupled to the shaft and the torsion mechanism, and the stop cap is configured to rotate at least a portion of a turn in response to rotational force applied from the torsion mechanism to seat on the distal face or the proximal face. In some embodiments, the plunger may include a spring configured to return the plunger to the uncompressed position after each movement, for example, each depression.

Another general aspect of the present disclosure includes an apparatus comprising a plunger and a shaft operatively coupled to the plunger. In operation, in response to a first axial movement of the plunger from an uncompressed position to a compressed position, the shaft may extend to an extended position and remain in the extended position after release of the force causing the first axial movement, and the plunger may move to the uncompressed position after release of the force causing the first axial movement. In response to the next axial movement of the plunger from the uncompressed position to the compressed position, the shaft may retract to a retracted position and remain in the retracted position after release of the force causing the second axial movement, and the plunger may move to the uncompressed position in response to release of the force causing the second axial movement. The shaft does not extend beyond the extended position at any time.

Implementations may include one or more of the following features. In some embodiments, the apparatus may include a torsion mechanism coupled to the plunger and a stopping mechanism coupled to the torsion mechanism and the shaft. In response to the first axial movement, the torsion mechanism may rotate a number of degrees (e.g., 30, 45, 90, etc.) about an axis (a partial rotation) that extends the length of the plunger. The stopping mechanism may move axially along the axis and complete the partial rotation to lock in a distal position corresponding to the extended position of the shaft. In response to the next axial movement, the torsion mechanism may rotate the partial rotation, and the stopping mechanism may move axially along the axis and rotationally through the partial rotation to lock in a proximal position corresponding to the retracted position.

In some embodiments, the torsion mechanism may include a rotator coupled to the plunger, a ratchet coupled to the rotator, a stopper with ratchet positions that is coupled to the ratchet, and a torsion spring coupled to the stopper and the stopping mechanism. In response to each axial movement of the plunger, the rotator may rotate the partial rotation, the ratchet may rotate with the rotator, the stopper may lock the torsion mechanism rotationally and apply rotational force to the torsion spring, and the torsion spring may apply rotational force to the stopping mechanism.

In some embodiments, the torsion mechanism may include a rotator coupled to the plunger, a torsion spring housing coupled to the rotator, a one-way roller clutch coupled to the rotator, and the torsion spring coupled to the torsion spring housing and the stopping mechanism. In response to each axial movement of the plunger, the rotator may rotate the partial rotation, the torsion spring housing may rotate with the rotator and apply rotational force to the torsion spring, the one-way roller clutch may lock the torsion mechanism rotationally, and the torsion spring may apply rotational force to the stopping mechanism.

In some embodiments, the stopping mechanism may include a housing that has at least one proximal face corresponding to the proximal position, at least one distal face corresponding to the distal position, and channels connecting the proximal faces and the distal faces. The stopping mechanism may further include a stop cap that has flanges seated within the channels of the housing. The stop cap may be coupled to the shaft and the torsion mechanism. In response to the first axial movement, which can be a first depression of the plunger, the stop cap may move axially along the channels in the housing, and the stop cap may rotate the partial rotation in response to rotational force applied from the torsion mechanism to seat on the distal faces of the housing. In response to a next depression of the plunger, the stop cap may move axially along the channels in the housing and rotate the partial rotation in response to the rotational force applied from the torsion mechanism to seat on the proximal faces of the housing.

In some embodiments, the apparatus may include a clamping mechanism coupled to the shaft. In response to the first axial movement, the clamping mechanism may be in one of a clamped position or an unclamped position in response to the shaft extending to the extended position. In response to the next axial movement, the clamping mechanism is in the opposite of the clamped position or the unclamped position in response to the shaft retracting to the retracted position. In some embodiments, the clamping mechanism may include an electrode configured to apply nanosecond pulses to tissue enclosed within the clamping mechanism in the clamped position.

In some embodiments, the plunger may include a spring configured to return the plunger to the uncompressed position after release of the plunger after each axial movement (e.g., depression or retraction).

In some embodiments, the extended position corresponds to one of a latched position or an unlatched position and the retracted position corresponds to the opposite of the latched position or the unlatched position.

Another general aspect an apparatus configured to provide a zero over-travel. The apparatus may include a housing that has a proximal stop position and a distal stop position. The apparatus may include an outer plunger and a rotator inside the housing such that the outer plunger and the rotator are operatively coupled to each other. The apparatus may include a torsion spring coupled to the rotator. The apparatus may include a stopper coupled to the torsion spring, the stopper including one or more flanges. The apparatus may include a shaft coupled to the stopper such that one or more flanges are configured to seat on the proximal stop position or the distal stop position of the housing when the outer plunger is moved axially and such that the shaft never extends distally beyond an extended position corresponding to the distal stop position of the housing.

Implementations may include one or more of the following features. In some embodiments, the outer plunger and the rotator may be coupled by a cam slot and a pin. In some embodiments a retracted position of the shaft may correspond to the proximal stop position, the extended position may correspond to one of a latched position or an unlatched position of the apparatus, and the retracted position may correspond to an opposite of the one of the latched position or the unlatched position of the apparatus.

Other features and advantages of the devices and methods of the present disclosure will become apparent from the following detailed description of various implementations.

### BRIEF DESCRIPTION OF THE DRAWINGS

FIG. 1 illustrates an example of an exploded view of a push-push mechanism with zero overtravel, according to some embodiments.

FIG. 2 illustrates an example of an exploded view of a portion of the push-push mechanism with zero overtravel of FIG. 1, according to some embodiments.

FIG. 3 illustrates a cross-sectional view of a push-push mechanism with zero overtravel in the unlatched state, according to some embodiments.

FIG. 4 illustrates a cross-sectional view of a push-push mechanism with zero overtravel when the plunger is being depressed, according to some embodiments.

FIG. 5 illustrates a cross-sectional view of a push-push mechanism with zero overtravel in the latched state, according to some embodiments.

FIG. 6 illustrates an example of an exploded view of another push-push mechanism with zero overtravel, according to some embodiments.

FIG. 7 illustrates a cross-sectional view of an example of a push-push mechanism with zero overtravel, according to some embodiments.

FIG. 8 illustrates an example of a view of a push-push mechanism with zero overtravel incorporated into an instrument with a clamping mechanism, according to some embodiments.

FIG. 9 illustrates a nanosecond pulse generator which may be used with various instruments and apparatuses according to some embodiments.

### DETAILED DESCRIPTION

As discussed above, known push-to-open and push-to-close mechanisms are typically designed to require an overtravel. Overtravel occurs when the object being opened or closed travels past the open point so that a latch or other fastening mechanism can engage or disengage. In a typical push-to-open and push-to-close example, such as a ballpoint pen, the tip of the pen extends beyond the open position used to write so that the latch holding the tip of the pen in the writing position can engage when opening and disengage when closing.

In medical applications, overtravel is undesirable. For example, when using a clamp, additional travel when opening or closing the clamp may cause damage to tissue or pain to the patient. Apparatuses, systems, and methods of the present disclosure avoid these issues by providing a push-to-open and push-to-close mechanisms with no (zero) overtravel. Further, for ease of the operation, the same motion is used to latch and unlatch (e.g., open and close) the device. As a result, the end of an instrument (e.g., medical clamp) never travels beyond the final latched/unlatched (e.g., open or closed) positions.

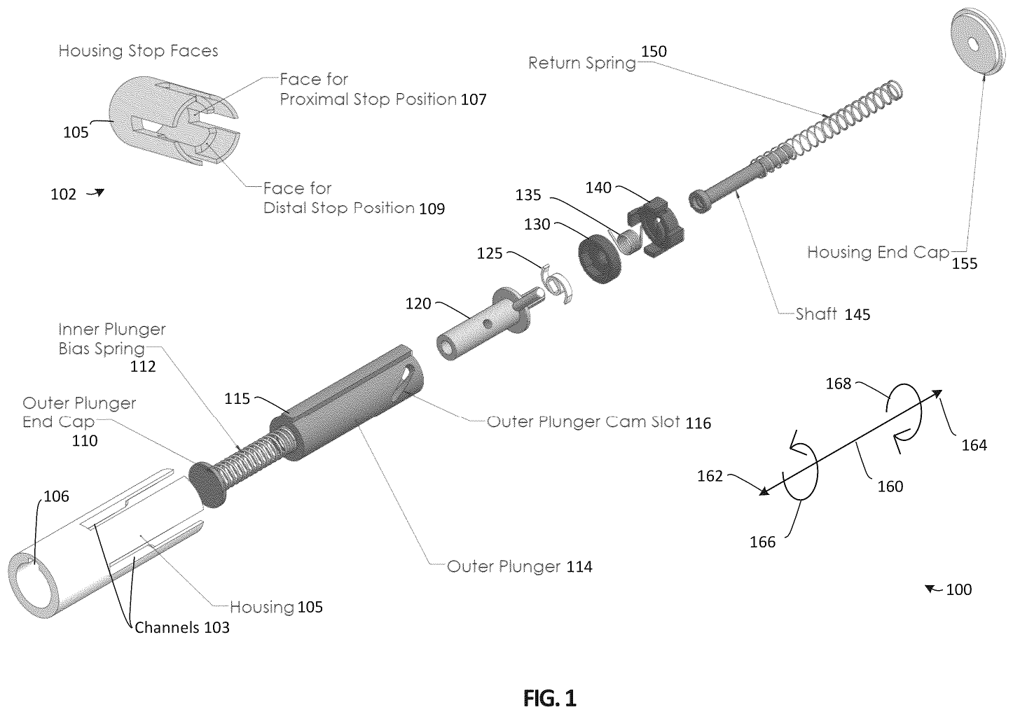

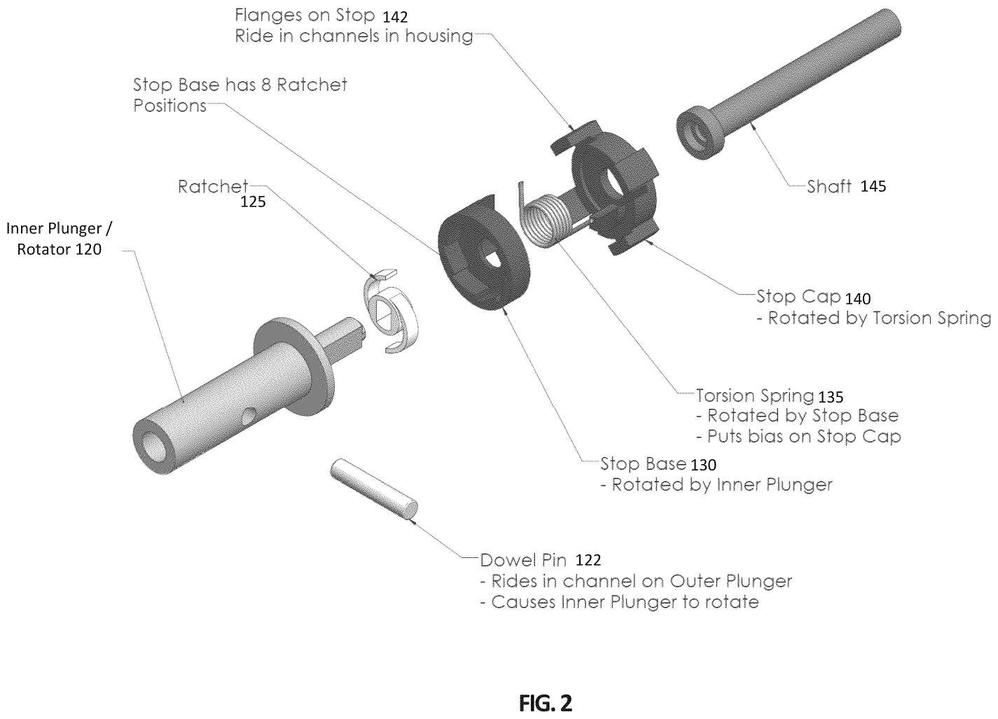

Turning now to the figures, FIG. 1 illustrates an example of an exploded view of an apparatus 100, and FIG. 2 illustrates an exploded view of several components shown in FIG. 1. For convenience, FIGS. 1 and 2 are described together. Apparatus 100 is one example of the zero overtravel push-to-open and push-to-close device. Apparatus 100 may include a housing 105, outer plunger end cap 110, inner plunger bias spring 112, outer plunger 114, inner plunger or rotator 120, ratchet 125, stop base 130, torsion spring 135, stop cap or a stopper 140, shaft 145, return spring 150, and housing end cap 155.

For purposes of directional illustration, axis 160 is shown with plunger (e.g., proximal) end 162 and shaft (e.g., distal) end 164. When looking from the plunger end 162 to the shaft end 164, rotation is described as counterclockwise 166 and clockwise 168. It should be understood that throughout the descriptions of the drawings, movement may occur in a reversed direction of the description. For example, motion described as clockwise may also occur counterclockwise in some embodiments. Similarly, movement in an axial direction may be described as pushing but may also apply to pulling or retraction.

Examples of the components of apparatus 100 work together to perform various functions. In the example of FIGS. 1 and 2, a plunger mechanism (which also referred to as a plunger) includes the outer plunger end cap 110, inner plunger bias spring 112, and outer plunger 114. A torsion mechanism may include the inner plunger 120 (also referred to as a rotator), ratchet 125, stop base 130, and torsion spring 135. A stopping mechanism may include a stop cap/stopper 140 and housing 105. These components work together as discussed herein. It should be understood that various components may be combined together in a single component or part, or some component may be substituted for a different component that performs the same or similar function. In some examples, instead of a spring, a coil or an elastomer part may be used.

Housing 105 may be metal, plastic, or any other material that can be formed as described and shown. Housing 105 may include one or more channels 103 that are used to control motion of a stop cap 140. Housing 105 of an example of FIG. 1 includes a distal end that includes a channel 106 that a flange 115 of outer plunger 114 slides along. Housing 105 may also include housing stop faces, shown with more detail in view 102. As shown, housing 105 includes a number of faces for proximal stop position 107 and a number of faces for distal stop position 109. When apparatus 100 is, for example, in the distal position, face for distal stop position 109 is used. When apparatus 100 is in the proximal position, face for proximal stop position 107 is used. Between the faces for proximal stop position 107 and faces for distal stop position 109 are channels that flanges on stop cap 140 ride axially along as discussed in more detail below.

Outer plunger end cap 110 and outer plunger 114 may be metal, plastic, or any other material that can be formed as described and shown herein. Outer plunger end cap 110 is seated on the end of outer plunger 114. Inner plunger bias spring 112 keeps the outer plunger 114 biased proximally (i.e., extended) relative to the inner plunger. Inner plunger bias spring 112 may be made of metal, plastic or any other material that can be formed as described and shown. Inner plunger bias spring 112 may be of sufficient tension to ensure the plunger (i.e., outer plunger end cap 110 and outer plunger 114) is extended when no force is applied (i.e., biased proximally. Further, the tension may be sufficiently low to ensure apparatus 100 may be opened and closed without undue exertion. Outer plunger end cap 110 withstands force applied axially from the plunger end 162 toward the shaft end 164, for example, when a user may press the outer plunger end cap 110 to move (e.g., depress in a distal direction) the outer plunger 114. A flange 115 slides within a channel 106 of housing 105 as the outer plunger end cap 110 is pressed.

Outer plunger 114 may further include outer plunger cam slot 116. In the example of FIG. 2, a dowel pin 122 (see FIG. 2) sits within outer plunger cam slot 116 to rotate inner plunger 120.

Inner plunger 120 may be metal, plastic, or any other material that can be formed as described and shown herein. Inner plunger/rotator 120 may include a hole to house dowel pin 122 (see FIG. 2). Dowel pin 122 may be metal, plastic, or any other material that can be formed and function as described and shown herein. Dowel pin 122 may sit within rotator and outer plunger cam slot 116. As outer plunger 114 moves axially down inner plunger 120, dowel pin 122 forces inner plunger 120 to rotate with respect to outer plunger 114 based on the angle and length of outer plunger cam slot 116.

Ratchet 125 may be metal, plastic, or any other material that can be formed and function as described and shown herein. Ratchet 125 may include any number of ratcheting wings, though two are shown in FIGS. 1 and 2. Ratchet 125 is coupled to and rotates with inner plunger 120. As shown in FIG. 2, ratchet 125 has a hole in the center in which an extension of inner plunger 120 sits snugly so that when inner plunger 120 rotates, ratchet 125 rotates with inner plunger 120.

Stop base 130 may be metal, plastic, or any other material that can be formed and function as described and shown herein. Stop base 130 may include ratchet positions (see FIG. 2). Any number of ratchet positions may be used, though eight (8) are shown in FIG. 2. As rotator 120 forces ratchet 125 to rotate clockwise 168, the ratchet wings of ratchet 125 force stop base 130 to rotate clockwise because the ratchet wings push within the stop base 130 on the ratchet positions. When the plunger is released and rotator 120 rotates counterclockwise 166 due to dowel pin 122 rotating back in outer plunger cam slot 116, ratchet 125 rotates counterclockwise 166 as well. However, ratchet 125 slides along stop base 130 to the next ratchet position so that stop base 130 may not rotate counterclockwise 166 or not as far as ratchet 125 rotates. It should be understood that counterclockwise and clockwise directions of the rotations may be reversed in some implementations.

Torsion spring 135 may be seated against stop base 130. Stop base 130 may have an extension on the distal side that can be seen in FIG. 2. The extension may force torsion spring 135 to rotate and put rotational force on stop cap/stopper 140. Torsion spring 135 may be metal or any other material that can be formed and function as described and shown herein. Torsion spring 135 may have sufficient tension to force stop cap 140 to rotate when flanges 142 of stop cap 140 clear channels in housing 105 without causing undue force on the coupled components including stop cap 140 that could break flanges 142.

Stop cap 140 may be metal, plastic, or any other material that can be formed and function as described and shown herein. Stop cap 140 may include flanges 142 (see FIG. 2) that ride in the channels 103 in housing 105 between the faces in housing 105. When the flanges 142 clear the channels 103 in housing 105, stop cap 140 rotates due to the rotational force from torsion spring 135. Stop cap 140 rotates the number of degrees that rotator/inner plunger 120 rotates by virtue of each of the intervening components (i.e., ratchet 125, stop base 130, torsion spring 135) rotating that same number of degrees. At each rotation, the flanges 142 of stop cap 140 seat on the corresponding faces of housing 105. Accordingly, for example, on a first depression of outer plunger 114, when outer plunger 114 is released, flanges 142 may be seated on face for distal stop position 109, so that shaft 145 is extended to an extended position (i.e., latched). When outer plunger end cap 110 is released, outer plunger 114 returns to the initial position due to inner plunger bias spring 112. On the next depression of outer plunger 114, when outer plunger 114 is released, flanges 142 will be seated on face for proximal stop position 107, so that shaft 145 is retracted to a retracted position (i.e., unlatched). At no time (e.g., upon any axial movement of the plunger between the compressed and uncompressed state) does shaft 145 extend past the extended position because to latch and unlatch apparatus 100, overtravel is not needed or performed. Note that in this description, when the shaft 145 is in an extended position, the apparatus 100 is described as latched and when the shaft 145 is in the retracted position, the apparatus 100 is described as unlatched. However, in some examples, when the shaft 145 is in the extended position, apparatus 100 may be unlatched, and when the shaft 145 is in the retracted position, apparatus 100 may be latched. Further, it should be understood that extending the shaft of an apparatus to the extended position may be used to either open or close jaws of a clamp or either latching or unlatching an end of the apparatus such that when the shaft is in the retracted position, the opposite is true. For example, if the extended position opens the clamp jaws, then the retracted position closes the clamp jaws, and if the extended position closes the clamp jaws, then the retracted position opens the clamp jaws.

Shaft 145 may be metal, plastic, or any other material that can be formed and function as described and shown herein. In some embodiments, shaft 145 may be coupled to an end of an instrument or a treatment applicator that performs a function for apparatus 100. For example, in some implementations shaft 145 may be a tube that allows, for example, infusion or vacuum if desired in the apparatus 100. As another example, shaft 145 may be coupled to a clamp, for example a cardiac clamp, such that when shaft 145 is in the distal or extended position, the clamp is open, and when shaft 145 is in the proximal or retracted position, the clamp is closed. In yet a further example, shaft 145 may be coupled to a clamp such that when shaft 145 is in the distal or extended position, the clamp is closed, and when shaft 145 is in the proximal or retracted position, the clamp is open. In some embodiments, an electrode may be coupled to the clamp as described above or coupled to a tip of shaft 145 such that an electrical signal may be applied to tissue using the electrode.

Return spring 150 may be metal or any other material that can be formed and function as described and shown herein. Return spring may be of sufficient tension and length to keep the proximal end of shaft 145 pressed against stop cap 140. Housing end cap 155 may be metal, plastic, or any other material that can be formed and function as described and shown herein. Housing end cap 155 seats against housing 105 and provides a stopping end for return spring 150. Housing end cap 155 may include a hole through which shaft 145 projects.

In use, the plunger remains in an extended or uncompressed position due to inner plunger bias spring 112. To open or close (i.e., engage or disengage, or latch or unlatch) the apparatus 100, the outer plunger end cap 110 may be pushed (or pulled in some implementations), for example, by a user or otherwise, exerting a force sufficient to compress inner plunger bias spring 112, thereby moving the plunger from an extended/decompressed/uncompressed state to a compressed state.

As the outer plunger 114 moves axially along axis 160, inner plunger 120 does not initially move axially relative to the housing. Then dowel pin 122, which is seated within outer plunger cam slot 116, forces the inner plunger 120 to move rotationally (turn) in response to dowel pin 122 (See FIG. 2) moving within outer plunger cam slot 116. Accordingly, inner plunger 120 may be referred to as a rotator. As rotator/inner plunger 120 rotates clockwise 168, it forces ratchet 125 to rotate in the same direction. As ratchet 125 turns, the ratchet stop positions in stop base 130 force stop base 130 to rotate clockwise 168.

Stop base 130 turning clockwise 168 puts rotational force on torsion spring 135 in the clockwise 168 direction. Torsion spring 135 in turn puts rotational force on stop cap 140 in the clockwise 168 direction. Stop cap 140 has flanges 142 that ride in the channels 103 in housing 105. As the flanges clear the channels, stop cap 140 rotates clockwise 168 to seat first, for example, into a face for distal stop position 109. In this example, each depression of the outer plunger causes a forty-five (45) degree rotation of the described components, and alternately the stop cap 140 seats in the face for proximal stop position 107 and the face for distal stop position 109. While forty-five degrees is used in this example, any number of degree rotation can be used. The degree each component turns with each depression of the plunger may be selected based on the length and direction of outer plunger cam slot 116.

When stop cap 140 seats in the proximal stop position 107, apparatus 100 may be in the unlatched state, and shaft 145 is not extended. When stop cap 140 seats in the distal stop position 109, apparatus 100 may be in the latched state, and shaft 145 is extended. Advantageously, shaft 145 never extends distally past the position it is in when stop cap 140 is seated in the distal stop position 109.

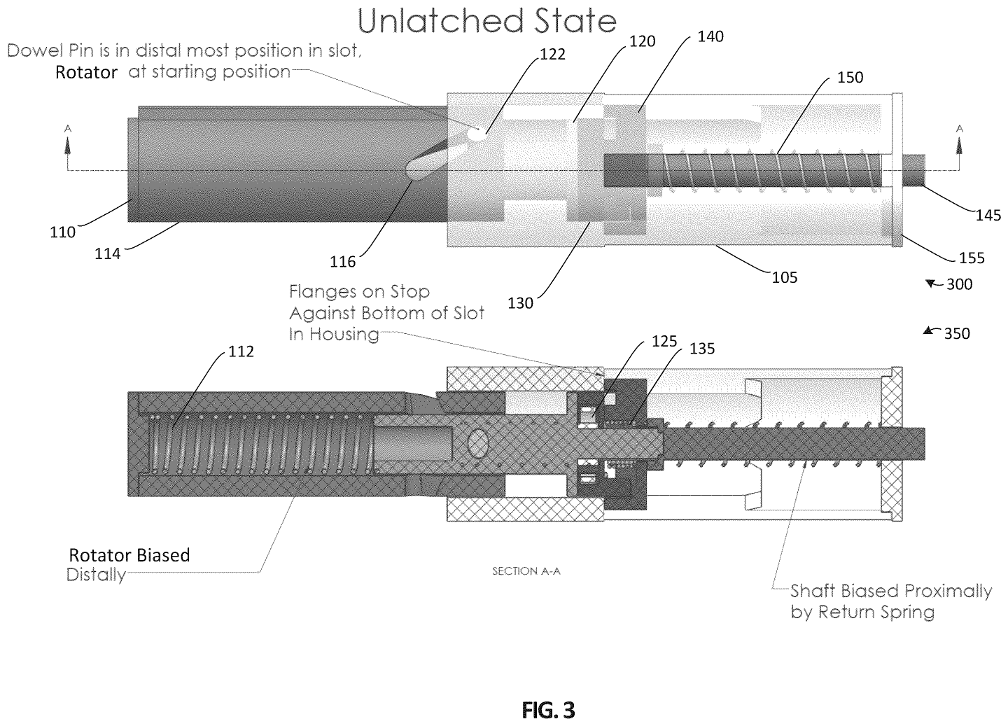

FIG. 3 illustrates a view 300 of apparatus 100 in the unlatched position and a cross sectional view 350 of the same. In view 300, housing 105 is translucent so the inner components may be seen. As shown, outer plunger 114 is in the uncompressed state, and dowel pin 122 is in the distal most position in outer plunger cam slot 116. Further, the flanges on stop cap 140 seated in housing 105 are on the face of the proximal stop position 107. Shaft 145 is not extended and is in the proximal position. The return spring 150 forces shaft 145 to be biased proximately to remain in the non-extended position.

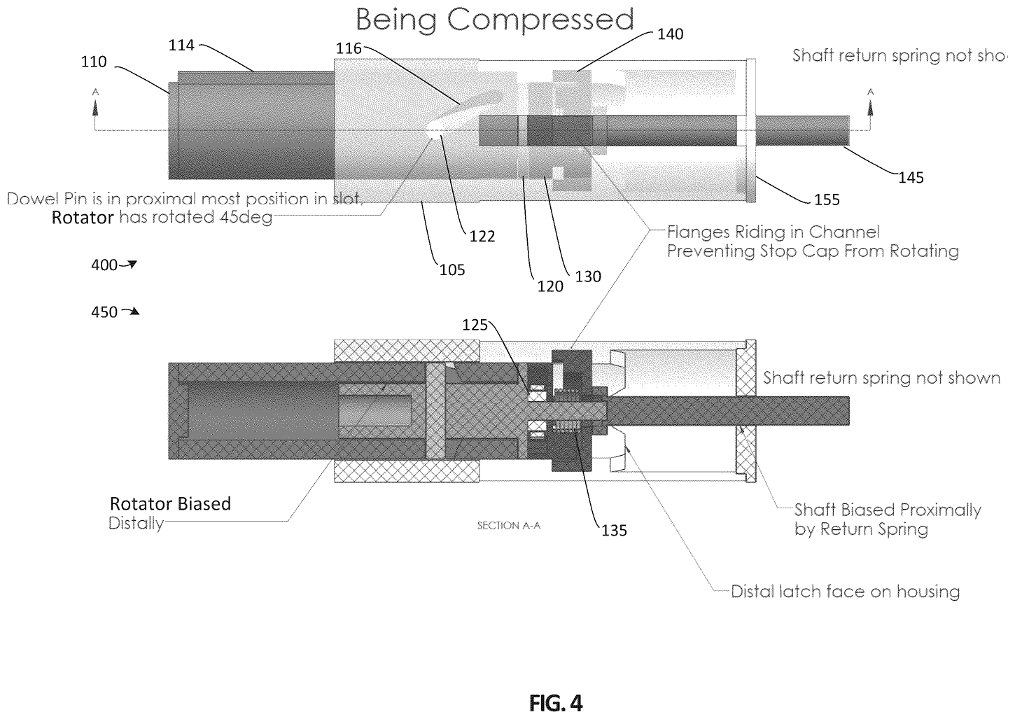

FIG. 4 illustrates a view 400 of apparatus 100 being compressed and a cross sectional view 450 of the same. In view 400, housing 105 is translucent so the inner components can be seen. As shown, outer plunger 114 is in the compressed state, and dowel pin 122 is in the proximal most position in outer plunger cam slot 116. Further, the flanges on stop cap 140 are within the channels of housing 105 that prevent stop cap 140 from rotating until the flanges clear the channels.

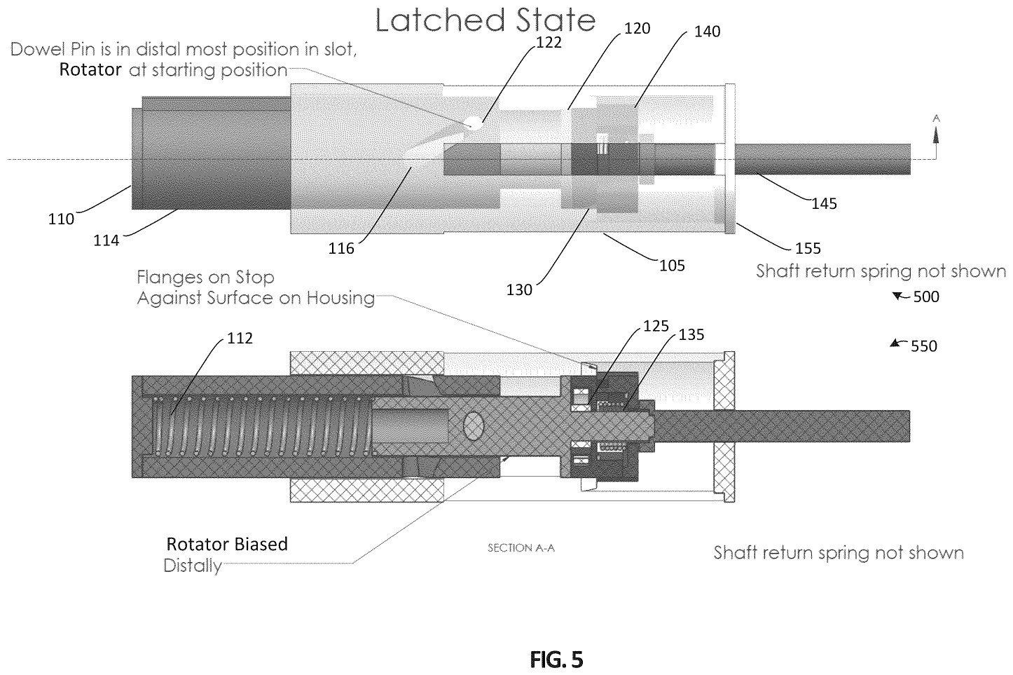

FIG. 5 illustrates a view 500 of apparatus 100 in the latched position and a cross sectional view 550 of the same. In view 500, housing 105 is translucent so the inner components can be seen. As shown, outer plunger 114 is in the decompressed state, and dowel pin 122 is in the distal most position in outer plunger cam slot 116. Note that this is the same as in the unlatched position as shown with respect to FIG. 3. The flanges on stop cap 140 seated in housing 105 are on the face of the distal stop position 109. Shaft 145 is extended and is in the distal or extended (e.g., latched) position.

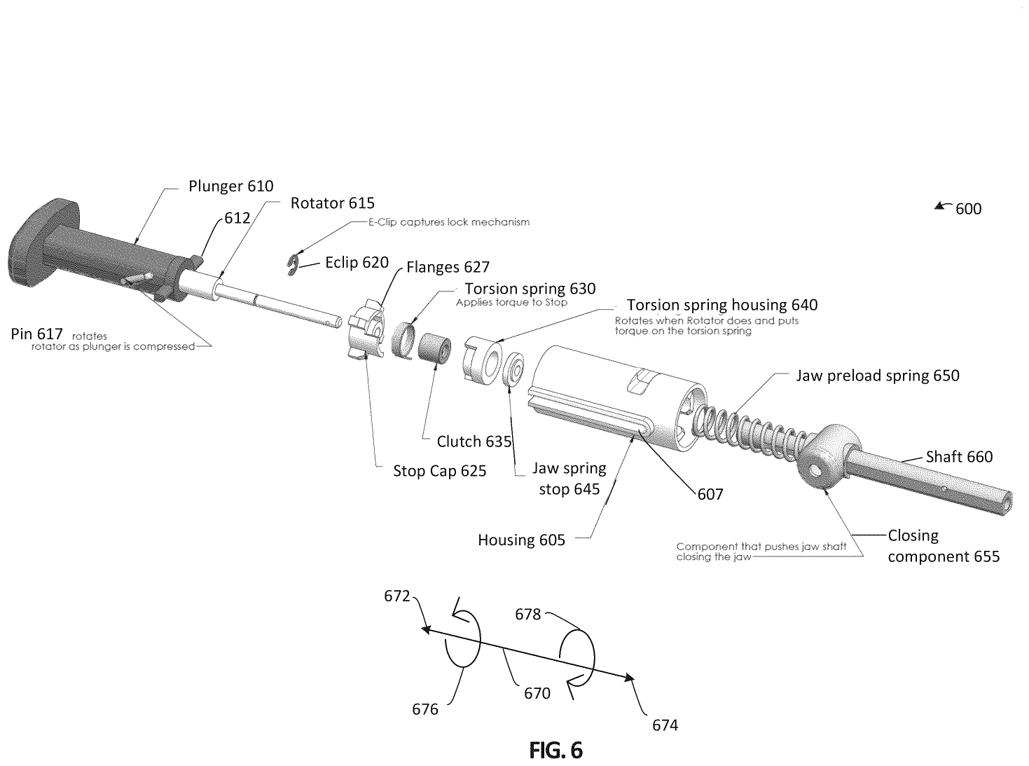

FIG. 6 illustrates an exploded view of another example of the push-push apparatus 600. Apparatus 600 is one embodiment of the zero overtravel push-to-open and push-to-close device. Apparatus 600 may include a housing 605, plunger 610, rotator 615, pin 617, stopper or stop cap 625, torsion spring 630, one-way roller clutch 635, torsion spring housing 640, jaw spring stop 645, jaw preload spring 650, closing component 655, and shaft 660. It may also optionally include eclip 620.

For purposes of directional illustration, axis 670 is shown with plunger end 672 (which may be also referred to as a proximal end) and shaft end 674 (which may be also referred to as a distal end). When looking from the plunger end 672 to the shaft end 674, rotation is described as clockwise 678 and counterclockwise 676.

A torsion mechanism may include rotator 615, torsion spring 630, one-way roller clutch 635, and torsion spring housing 640. A stopping mechanism may include stopper 625 and housing 605. These components work together as discussed below.

Housing 605 may be substantially similar to housing 105 as described with respect to FIG. 1. Housing 605 may include housing stop faces, which may include a number of faces for a proximal stop position and a number of faces for a distal stop position. When apparatus 600 is in the distal position, the faces for the distal stop position are used. When apparatus 600 is in the proximal position, the faces for the proximal stop position are used. Between the faces for the proximal stop position and the faces for the distal stop position are channels that flanges 627 on stopper 625 slide axially along.

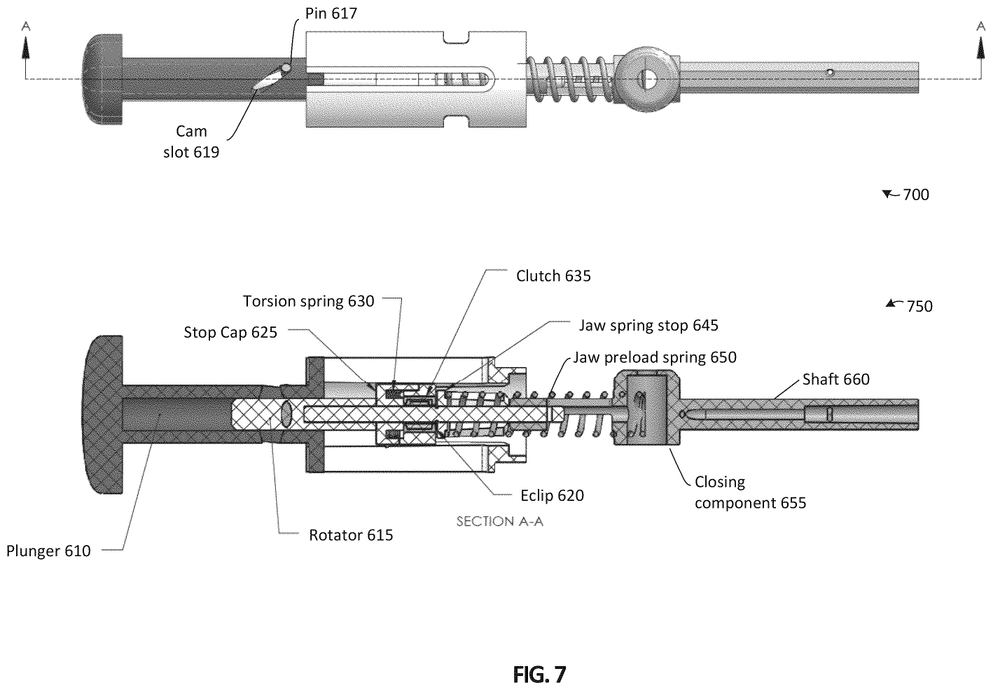

Plunger 610 may be plastic, metal, or any other material that can be formed and function as described and shown herein. Plunger 610 may include a cam slot 619 (shown in FIG. 7) in which pin 617 may slide. The cam slot 619 of plunger 610 may be similar to outer plunger cam slot 116 as shown and discussed with respect to FIG. 1. Plunger 610 may further include channel sliders 612, which may slide in channels 607 of housing 605 when plunger 610 is depressed.

Rotator 615 may be metal, plastic, or any other material that can be formed and function as shown and described herein. Rotator 615 slides within plunger 610 and includes pin 617. As plunger 610 moves axially to depress the plunger, pin 617 forces rotator 615 to rotate, for example, clockwise 678. The degree of the rotation is based on the cam slot 619 that pin 617 slides in. When plunger 610 is released, rotator 615 rotates, for example, counterclockwise 676 back to the original position.

As rotator 615 rotates, one-way clutch forces torsion spring housing 640 to rotate with rotator 615 in the clockwise 678 direction when plunger 610 is depressed. When the plunger is released, it allows rotator 615 to rotate in the counterclockwise 676 direction while torsion spring housing 640 does not rotate.

Torsion spring 630 may be seated within torsion spring housing 640 and seated against stop cap 625. Torsion spring 135 may be metal or any other material that can be formed and function as described and shown herein. Torsion spring 135 may have sufficient tension to force stop cap 625 to rotate when flanges 627 of stop cap 625 clear the channels in housing 105 without causing undue force on the coupled components including stop cap 625 that could break flanges 627. The torsion spring housing 640 may apply rotational force to torsion spring 630 when torsion spring housing 640 rotates clockwise 678. The clockwise 678 rotational force on torsion spring 630 may cause stop cap 625 to want to rotate clockwise 678, but the flanges 627 of stop cap 625 do not allow stop cap 625 to rotate until the flanges 627 clear the channels in housing 605.

One-way roller clutch 635 may be metal, plastic, rubber, or any other material that can be formed and function as shown and described herein. One-way roller clutch 635 freely rotates in one direction, but locks rotation in the other direction. In this case, one-way roller clutch 635 sits within torsion spring housing 640. When rotator 615 rotates, one-way roller clutch rotates clockwise 678, but not counterclockwise 676 so that torsion spring housing 640 does not rotate back with the rotator 615.

Stop cap 625 may be metal, plastic, or any other material that can be formed and function as shown and described herein. Stop cap 625 may include flanges 627 that slide in the channels between the faces in housing 605. When flanges 627 clear the channels in housing 605 based on the axial movement caused, for example, by the depression on plunger 610 (or in some embodiments the direction may be reversed and the axial movement may be caused by retraction instead of depression), stop cap 625 rotates due to the rotational force from torsion spring 630. Stop cap 625 rotates the number of degrees that rotator 615 rotates by virtue of each of the intervening components (i.e., one-way clutch 635, torsion spring housing 640, torsion spring 630) rotating that same number of degrees. At each rotation, the flanges 627 of stop cap 625 seat on the corresponding faces of housing 605. Accordingly, for example, on a first depression of plunger 610, when plunger 610 is released, flanges 627 may be seated on the distal stop position faces. When plunger 610 is released, it returns to the initial position due to a spring (not shown) within plunger 610. On the next depression of plunger 610, when the plunger 610 is released, flanges 627 may be seated on the proximal stop position faces.

Jaw spring stop 645 may be plastic, rubber, metal, or any other material that can be formed and function as shown and described herein. Jaw spring stop 645 is seated against jaw preload spring 650 and torsion spring housing 640. When stop cap 625 is seated on the distal faces, jaw spring stop 645 is in a distal position, and jaw preload spring 650 is pushed distally. When stop cap 625 is seated on the proximal faces of housing 605, jaw spring stop 645 is retracted to a proximal position based on the tension from jaw preload spring 650, and jaw preload spring is in a proximal position. Jaw preload spring 650 may be metal or any other material that may be formed and function as described and shown herein. Jaw preload spring 650 does not experience much compression because it moves axially from the proximal position to the distal position, pushing closing component 655 along shaft 660.

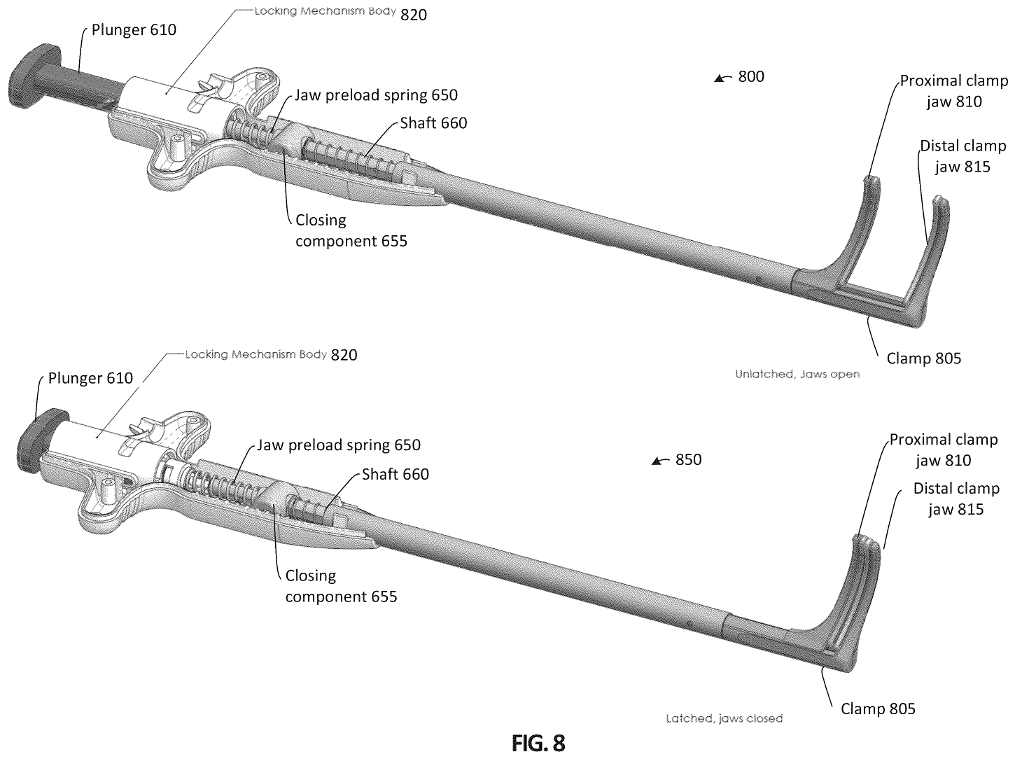

Closing component 655 may be metal, plastic, or any other material that can be formed and function as described and shown herein. Closing component 655 may be coupled, for example, to a clamp end (not shown). Closing component 655 may be coupled to jaw preload spring 650 so that when jaw spring stop 645 moves axially, jaw preload spring 650 forces closing component 655 to slide axially along shaft 660. In some embodiments, the closing component 655 may be coupled to one jaw of a clamp and may cause the clamp to open and close as closing component 655 moves axially. This type of clamping mechanism is shown in more detail with respect to FIG. 8. Advantageously, the closing component 655 never extends further than the distal position, so that no overtravel is required to open or close the mechanism, such as a clamp, attached to closing component 655.

Shaft 660 may be metal, plastic, or any other material that can be formed and function as described and shown herein. In some embodiments, shaft 660 may be coupled to an end that performs a function for apparatus 600. For example, in case of the clamp (e.g., cardiac clamp, or parallel jaws clamp) shaft 660 may be coupled to a static jaw of a clamp such that when closing component 655 is in the distal or extended position, the clamp may be open, and when closing component 655 is in the proximal or retracted position, the clamp is closed. In some embodiments, an electrode may be coupled to the clamp such that an electrical signal may be applied to tissue using the electrode.

In use, plunger 610 remains in an extended position due to an inner plunger bias spring (not shown). To open or close (i.e., engage or disengage, latch or unlatch) apparatus 600, the plunger 610 may be pushed (for example, by a user), exerting a force sufficient to compress the spring, thereby depressing the plunger mechanism from a decompressed state to a compressed state.

As plunger 610 moves axially along axis 670, pin 617 on rotator 615, which is seated within a cam slot 619 in plunger 610, forces rotator 615 to move rotationally (turn) in response to the pin 617 moving within the cam slot 619. As rotator 615 rotates, for example, clockwise 678, a one-way clutch coupled to the torsion spring housing 640 forces torsion spring housing 640 to rotate clockwise 678. As torsion spring housing 640 rotates, it applies rotational force in the clockwise 678 direction to the torsion spring 630. The force on torsion spring 630 in turn applies clockwise 678 force to stop cap 625. Meanwhile, plunger 610 pushes stop cap 625 axially along the channels in housing 605 until flanges 627 on stop cap 625 clear the channels to rotate to the next face in housing 605, either proximal face or distal face (not shown). Based on the face that stop cap 625 is seated on from the compression of plunger 610, jaw preload spring 650 compresses to a position that opens or closes closing component 655. When plunger 610 is released, rotator 615 rotates counterclockwise 676, but the one-way clutch keeps the torsion spring housing from rotating.

In this example, when stop cap 625 seats in the proximal stop position, apparatus 600 is in the unlatched state, and closing component 655 is not extended (i.e., closed). When stop cap 625 seats in the distal stop position, apparatus 600 is in the latched state, and closing component 655 is extended (i.e., open). Advantageously, closing component 655 never extends distally past the position it is in when stop cap 625 is seated in the distal stop position.

FIG. 7 illustrates a view 700 of apparatus 600 and a cross sectional view 750 of the same. View 700 provides perspective for cross sectional view 750. As shown in view 700, pin 617 of the rotator 615 slides within cam slot 619 of plunger 610. As shown in cross sectional view 750, plunger 610 can be depressed which forces stop cap 625, torsion spring 630, one-way roller clutch 635, jaw preload spring 650, and closing component 655 to move axially. At the same time, pin 617 in cam slot 619 forces rotational movement so that when stop cap 625 clears the channels in housing 605, stop cap 625 rotates in response to the rotational force that was placed through each of the components rotator 615, torsion spring housing 640, torsion spring 630 as discussed above. The rotation of stop cap 625 moves stop cap 625 to a different face (proximal or distal) of housing 605 than it was previously seated on. When in the distal position, jaw preload spring 650 moves axially, in this example causing closing component 655 to move to the distal position, closing the clamp (shown in FIG. 8) coupled to closing component 655. When in the proximal position, jaw preload spring 650 moves axially (retracting), causing closing component to move to the proximal position, opening the clamp (shown in FIG. 8) coupled to the closing component 655.

FIG. 8 illustrates one example of a clamping device implementing the apparatus 600 discussed above with respect to FIGS. 6 and 7. View 800 shows the device in an unlatched position (for example, jaws open). View 850 shows the device in a latched position (for example, jaws closed). As shown in view 800, plunger 610 is not depressed. The stop cap within the locking mechanism body 820 is in the proximal position, making jaw preload spring 650 in the proximal position, and closing component 655 in the proximal position. Closing component 655 may be coupled to proximal clamp jaw 810, so that when closing component 655 is retracted in the proximal position, clamp 805 is open. As shown in view 850, plunger 610 is depressed and has not yet been released. The stop cap within the locking mechanism body 820 is in the distal position, making jaw preload spring 650 in the distal position, and closing component 655 in the distal position. When closing component 655 is extended in the distal position, the jaws of the clamp 805 are closed. To release, proximal clamp jaw 810 does not have to squeeze closer to distal clamp jaw 815 because there is no overtravel.

In some embodiments, closing component 655 may be coupled to distal clamp jaw 815 (making it the moving jaw), so that when the jaw preload spring 650 and closing component 655 are in the proximal position, clamp 805 is closed. Further, in this embodiment, when jaw preload spring 650 and closing component 655 are in the distal position, clamp 805 is open.

Clamp 805 may include curved or bent jaws 810, 815. In some embodiments, each jaw 810, 815 may include an electrode having a tissue contacting surface that may include rounded corners or edges (e.g., fillets). The electrode may also include rounded edges on non-tissue contacting edges or surfaces. The rounded edges on the non-tissue contacting or facing edges may reduce the peak electrical field and prevent arcing from this (e.g., lower) edge. Adding a rounded edge or corner can reduce the peak electric field, for example, by 15% to 30%, by 20% to 25%, depending on the type of the tissue. Any appropriate radius of the curvature for the rounded edge (fillet) may be used, for example, if the electrode has a thickness of t, the radius of curvature may be larger than about t/8 (e.g., larger than about t/7, larger than about t/6, larger than about t/5, larger than about t/4, larger than about t/3, between about t/8 and about 4t, between about t/8 and 2t, etc.). For example, in some apparatuses the radius of curvature of the curved edge (fillet) may be, for example, between about 0.1 mm to 0.5 mm for certain dimensions of the electrodes. The electrode in this example may be secured within an electrically insulating material.

Clamp 805 may have substantially parallel jaws positioned at an angle (for example, 90 degrees/perpendicular) to the shaft 660 but with the jaws 810, 815 having the bent or curved shape. The electrodes on clamp 805 may be positioned for clamping tissue therebetween, so they are positioned on the inner sides of each respective jaw 810, 815 and project from the respective jaws 810, 815 inwards (for example, by 1 mm, 2 mm, 3 mm). The electrodes may be secured within an electrically insulating material forming the base of each jaw 810, 815. The spacing between the jaws 810, 815, and therefore between the electrodes, may be adjusted using the plunger 610 to move, for example, either the proximal jaw 810 or the distal jaw 815 relative to each other. In some embodiments, the apparatus may be configured to detect spacing between the electrodes and send such spacing information to the control of the pulse generator system (e.g., pulse generator system 900) to adjust one or more parameters of the pulses, for example, voltage. Examples of the present system may be especially useful for treatment of cardiac arrhythmia, e.g., atrial fibrillation. For example, a slightly curved or bent configuration of the jaws 810, 815 may assist in isolation of the right and left pulmonary veins and creating other atrial lesions for preventing atrial fibrillation. The apparatuses of the present disclosure may provide a faster, more effective, and robust procedure to treat atrial fibrillation and such procedure may be performed with a single apparatus.

The apparatus 100 and 600 described above may include a treatment applicator or applicator (that comprises, for example, clamp 805 or other treatment instrument having electrodes) may be used with a system configured for delivery of electrical energy, including, for example, a pulse generator, an apparatus/applicator coupled to the pulse generator, and a controller controlling the pulse generator and delivery of energy by the applicator. The controller may include one or more processors, a memory and software/hardware and/or firmware. The controller may be a single processor or a series of processors that communicate with each other (wireless or by wired connection). In some examples the controller may be integrated with the pulse generator. Alternatively, the controller may be coupled with the pulse generator. In some examples the controller may be software that is run on a remote (e.g., cloud-based) server and that communicates and/or commands the pulse generator.

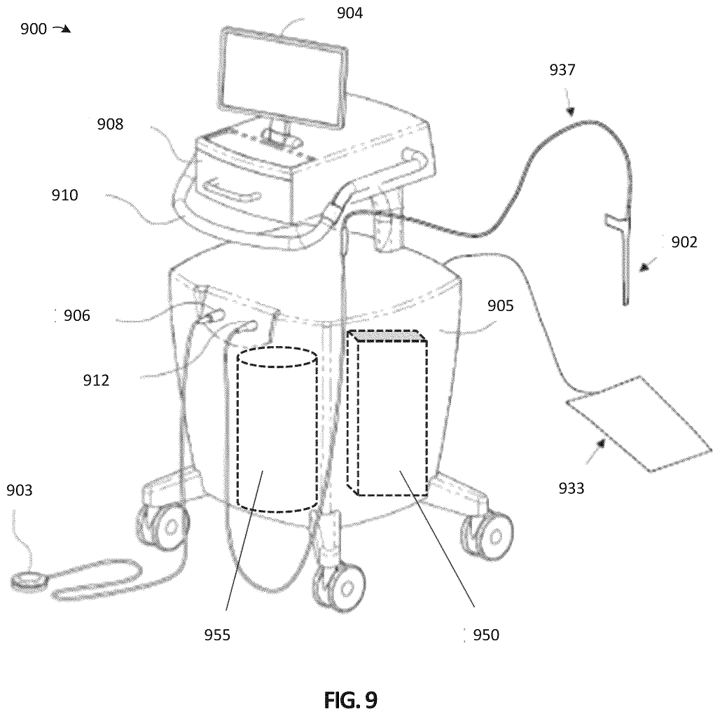

For example, FIG. 9 illustrates one example of a pulse generator system 900 including a pulse generator 955, applicator 902 and controller 950. The pulse generator 955 is shown within cabinet/housing 905, as is the controller 950. The controller 950 and pulse generator 955 may be connected to the various components (not shown) as well as each other. The pulse generator 955 is configured for delivering electric energy, for example, in some applications fast (e.g., sub-microsecond) pulses of electrical energy, or any other energy modality. The pulse generator system 900 may include an applicator 902 (shown by example as an elongated, hand-held applicator tool) that may, in some implementations, include one or more removably and/or disposable tips (not shown) for applying energy. For example, clamp 805 may be an applicator and may couple to the push-to-open and push-to-close apparatus 100 or 600 for clamping or otherwise engaging tissue without overtravel. The pulse generator system 900 may include one or more user controls or interfaces, including a footswitch 903, and manual user interface 904 (e.g., monitor such as a touchscreen). Footswitch 903 is connected to housing 905 (which may enclose the electronic components) through a cable and connector 906. The applicator 902 may include electrodes or may couple to a removable tip with electrodes and may be connected to housing 905 and the electronic components therein through a cable 937 and a connector 912, which may be a high-voltage connector. The pulse generator system 900 may also include a handle 910 and storage drawer 908. The pulse generator system 900 may also include a holder (e.g., holster, carrier, etc.) (not shown) which may be configured to hold the applicator 902. In some examples the system may be configured for monopolar treatment and may optionally include a dispersive electrode 933 (e.g., a return electrode pad).

Although various illustrative embodiments are described above, any of a number of changes may be made to various embodiments without departing from the scope of the disclosure. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

It is understood that the various embodiments described herein are by way of example only and are not intended to limit the scope of the invention. For example, many of the materials and structures described herein may be substituted with other materials and structures without deviating from the spirit of the invention as would be apparent to those skilled in the art upon review of the disclosure. Thus, although specific embodiments (examples) have been illustrated and described herein, any arrangement calculated to achieve the same purpose may be substituted for the specific examples shown. This disclosure is intended to cover any and all adaptations or variations of various examples. Combinations of the above examples or some features of the described examples, and other examples not specifically described herein, will be apparent to those of skill in the art upon reviewing the above description. The present invention as claimed may therefore include variations from the particular examples and embodiments described herein. It is understood that various theories as to why the invention works are not intended to be limiting. Various embodiments of the inventive subject matter may be referred to herein individually or collectively by the term “invention” merely for convenience and without intending to voluntarily limit the scope of this application to any single invention or inventive concept, if more than one is, in fact, disclosed.

All measurements, dimensions, and materials provided herein within the specification or within the figures are by way of example only. As used herein in the specification and claims, including as used in the examples and unless otherwise expressly specified, all numbers may be read as if prefaced by the word “about” or “approximately,” even if the term does not expressly appear.

A recitation of “a,” “an,” or “the” is intended to mean “one or more” unless specifically indicated to the contrary. Reference to a “first” component does not necessarily require that a second component be provided. Moreover, reference to a “first” or a “second” component does not limit the referenced component to a particular location unless expressly stated. When a feature or element is herein referred to as being “on” another feature or element, it can be directly on the other feature or element or intervening features and/or elements may also be present. It will also be understood that, when a feature or element is referred to as being “connected”, “attached” or “coupled” to another feature or element, it can be directly connected, attached, or coupled to the other feature or element or intervening features or elements may be present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

What is claimed is:

1. An apparatus, comprising:
a plunger configured to move between an uncompressed position and a compressed position;
a torsion mechanism coupled to the plunger and configured to rotate in response to the movement of the plunger;
a stopping mechanism coupled to the torsion mechanism and configured to move axially between a proximal position and a distal position in response to the rotation of the torsion mechanism; and
a shaft coupled to the stopping mechanism and configured to extend to an extended position in response to the stopping mechanism moving to the distal position and retract to a retracted position in response to the stopping mechanism moving to the proximal position,
wherein the shaft at no time moves beyond the extended position when the plunger moves between the compressed and uncompressed positions and the stopping mechanism moves between the proximal and distal positions.

2. The apparatus of claim 1, wherein the torsion mechanism is configured to rotate at least a portion of a turn about a longitudinal axis of the plunger in response to each axial movement of the plunger towards the compressed position.

3. The apparatus of claim 2, wherein the torsion mechanism is configured to lock rotationally after each axial movement of the plunger towards the compressed position.

4. The apparatus of claim 1, wherein the apparatus is latched in the extended position.

5. The apparatus of claim 1, wherein the torsion mechanism comprises:
a rotator coupled to the plunger and configured to rotate in response to each depression of the plunger to the compressed position;
a ratchet coupled to the rotator and configured to rotate with the rotator;
a stop base comprising ratchet positions and configured to lock the torsion mechanism rotationally and apply rotational force to a torsion spring; and
the torsion spring coupled to the stop base and configured to apply bias to the stopping mechanism.

6. The apparatus of claim 1, wherein the torsion mechanism comprises:
a rotator coupled to the plunger and configured to rotate in response to each depression of the plunger to the compressed position;
a torsion spring housing coupled to the rotator and configured to rotate with the rotator and apply rotational force to a torsion spring;
a one-way roller clutch coupled to the rotator and configured to lock the torsion mechanism rotationally; and
the torsion spring configured to apply rotational force to the stopping mechanism.

7. The apparatus of claim 1, further comprising a clamping mechanism coupled to the shaft and configured to open to an unclamped position and close to a clamped position in response to the shaft movement between the extended and the retracted positions.

8. The apparatus of claim 7, wherein the clamping mechanism further comprises an electrode configured to apply nanosecond pulses to tissue enclosed within the clamping mechanism in the clamped position.

9. The apparatus of claim 1, wherein the stopping mechanism comprises:
a housing comprising:
at least one proximal face corresponding to the proximal position,
at least one distal face corresponding to the distal position, and
channels connecting the at least one proximal face and the at least one distal face; and
a stop cap comprising flanges configured to be seated and move axially within the channels of the housing.

10. The apparatus of claim 9, wherein the stop cap is coupled to the shaft and the torsion mechanism and the stop cap is configured to rotate at least a portion of a turn in response to rotational force applied from the torsion mechanism to seat on the distal face or the proximal face.

11. The apparatus of claim 1, wherein the plunger comprises a spring configured to return the plunger to the uncompressed position after each axial movement.

12. An apparatus, comprising:
a plunger; and
a shaft operatively coupled to the plunger, wherein:
in response to a first axial movement of the plunger from an uncompressed position to a compressed position:
the shaft extends to an extended position and remains in the extended position after release of a force causing the first axial movement; and
the plunger moves to the uncompressed position in response to the release of the force causing the first axial movement,
in response to a next axial movement of the plunger from the uncompressed position to the compressed position:
the shaft retracts to a retracted position and remains in the retracted position after release of the force causing the next axial movement; and
the plunger moves to the uncompressed position in response to the release of the force causing the next axial movement, and
the shaft does not extend beyond the extended position at any time when the plunger moves between the compressed and uncompressed positions.

13. The apparatus of claim 12, further comprising:
a torsion mechanism coupled to the plunger; and
a stopping mechanism coupled to the torsion mechanism and the shaft, wherein:
in response to the first axial movement:
the torsion mechanism rotates a number of degrees about an axis that extends a length of the plunger; and
the stopping mechanism moves axially along the axis and rotationally the number of degrees to lock in a distal position corresponding to the extended position of the shaft, and
in response to the next axial movement:
the torsion mechanism rotates the number of degrees about the axis; and
the stopping mechanism moves axially along the axis and rotationally the number of degrees to lock in a proximal position corresponding to the retracted position.

14. The apparatus of claim 13, wherein the torsion mechanism comprises:
a rotator coupled to the plunger;
a ratchet coupled to the rotator;
a stopper comprising ratchet positions and coupled to the ratchet; and
a torsion spring coupled to the stopper and the stopping mechanism, wherein:
in response to each axial movement of the plunger:
the rotator rotates the number of degrees,
the ratchet rotates with the rotator,
the stopper locks the torsion mechanism rotationally and applies rotational force to the torsion spring, and
the torsion spring applies rotational force to the stopping mechanism.

15. The apparatus of claim 13, wherein the torsion mechanism comprises:
a rotator coupled to the plunger;
a torsion spring housing coupled to the rotator;
a one-way roller clutch coupled to the rotator; and
a torsion spring coupled to the torsion spring housing and the stopping mechanism wherein:
in response to each axial movement of the plunger:
the rotator rotates the number of degrees,
the torsion spring housing rotates with the rotator and applies rotational force to the torsion spring,
the one-way roller clutch locks the torsion mechanism rotationally, and
the torsion spring applies rotational force to the stopping mechanism.

16. The apparatus of claim 13, wherein the stopping mechanism comprises:
a housing comprising:
at least one proximal face corresponding to the proximal position,
at least one distal face corresponding to the distal position, and
channels connecting the at least one proximal face and the at least one distal face; and
a stop cap comprising flanges seated within the channels of the housing, the stop cap coupled to the shaft and the torsion mechanism, wherein:
in response to the first axial movement of the plunger:
the stop cap moves axially along the channels in the housing; and
the stop cap rotates the number of degrees in response to rotational force applied from the torsion mechanism to seat on the at least one distal face of the housing, and
in response to the next axial movement of the plunger:
the stop cap moves axially along the channels in the housing; and
the stop cap rotates the number of degrees in response to the rotational force applied from the torsion mechanism to seat on the at least one proximal face of the housing.

17. The apparatus of claim 12, further comprising:
a clamping mechanism coupled to the shaft, wherein:
in response to the first axial movement, the clamping mechanism is in one of a clamped position or an unclamped position in response to the shaft extending to the extended position; and
in response to the next axial movement, the clamping mechanism is in an opposite of the one of the clamped position or the unclamped position in response to the shaft retracting to the retracted position.

18. The apparatus of claim 17, wherein the clamping mechanism comprises an electrode configured to apply nanosecond pulses to tissue enclosed within the clamping mechanism in the clamped position.

19. The apparatus of claim 12, wherein the plunger comprises a spring configured to return the plunger to the uncompressed position after the release of the force causing each axial movement.

20. The apparatus of claim 12, wherein the extended position corresponds to one of a latched position or an unlatched position and the retracted position corresponds to an opposite of the one of the latched position or the unlatched position.

21. An apparatus configured to provide a zero over-travel, comprising:
a housing comprising a proximal stop position and a distal stop position;
an outer plunger and a rotator inside the housing, wherein the outer plunger and the rotator are operatively coupled to each other;
a torsion spring coupled to the rotator;
a stopper coupled to the torsion spring, the stopper comprising one or more flanges; and
a shaft coupled to the stopper,
wherein one or more flanges are configured to seat on the proximal stop position or the distal stop position of the housing when the outer plunger is moved axially such that the shaft never extends distally beyond an extended position corresponding to the distal stop position of the housing.

22. The apparatus of claim 21, wherein the outer plunger and the rotator are coupled by a cam slot and a pin.

23. The apparatus of claim 21, wherein a retracted position of the shaft corresponds to the proximal stop position, wherein the extended position corresponds to one of a latched position or an unlatched position of the apparatus and the retracted position corresponds to an opposite of the one of the latched position or the unlatched position of the apparatus.

24. The apparatus of claim 21, wherein the apparatus comprises a treatment applicator having one or more electrodes, the treatment applicator is configured to be operably connected to a system for delivery of electrical energy, the system comprising a pulse generator.
